(19) United States
(12) Patent Application Publication
(10) Pub. No.: US 2013/0182810 A1
(43) Pub. Date: Jul. 18, 2013

(54) TRAVELING REACTOR POWER MONITORING SYSTEM AND METHOD FOR DRIVING A TRAVELING PROBE

(71) Applicants: Toru Shijo, Tokyo (JP); Masataka Yanagisawa, Tokyo (JP); Tadashi Miyazaki, Kanagawa-ken (JP)

(72) Inventors: Toru Shijo, Tokyo (JP); Masataka Yanagisawa, Tokyo (JP); Tadashi Miyazaki, Kanagawa-ken (JP)

(73) Assignee: KABUSHIKI KAISHA TOSHIBA, Tokyo (JP)

(21) Appl. No.: 13/397,913

(22) Filed: Feb. 16, 2012

(30) Foreign Application Priority Data
Jan. 18, 2012 (JP) 2012-008416

(51) Int. Cl. G21C 17/00

(52) U.S. Cl. 376/245

(57) ABSTRACT

A traveling reactor power monitoring system includes a probe cable, a traveling prove connected to the probe cable, a storage reel storaging the probe cable, a motor feeding and spooling the probe cable, a drive control unit driving the motor at a scheduled drive speed, a torque sensor measuring a drive torque for moving the traveling probe and the probe cable, an aimed torque DB storing a first threshold and a second threshold, a drive information DB storing the drive torque and the drive speed that the drive control unit moved the traveling probe and a scheduled drive speed processor calculating the scheduled drive speed that is set faster than previous drive speed when the previous drive torque is smaller than the second threshold, and is set slower than previous drive speed when the previous drive torque is larger than the first threshold.

### CROSS-REFERENCE TO RELATED APPLICATION

This application is based upon and claims the benefit of priority from Japanese Patent Application No. 2012-008416, filed on Jan. 18, 2012, the entire content of which is incorporated herein by reference.

### FIELD OF THE INVENTION

The present invention relates to traveling reactor power monitoring system that moves a traveling probe in a nuclear reactor by feeding and spooling a probe cable in the reactor. More particularly, the invention is directed to a traveling reactor power monitoring system that moves the traveling probe at optimized drive speeds.

### BACKGROUND OF THE INVENTION

At a Boiled Water Reactor (BWR) power plant, in order to measure neutron flux in a nuclear reactor, Local Power Range Monitors (LPRMs) are provided in the reactor. Fissile material provided at the electrode in the LPRMs fissions and releases ionized atoms as a result of being irradiated with neutrons. Neutron flux is obtained by measuring the ionized atoms.

However, the LPRMs are placed in the reactor constantly and difficult to be replaced, and the sensitivity of the LPRMs declines with time because of consumption of the fissile material. Therefore, the sensitivity of the LPRMs needs to be calibrated arbitrarily in order to measure neutron flux in the reactor precisely.

At a Pressurized Water Reactor (PWR) power plant, in order to measure neutron flux in a nuclear reactor, fixed neutron sensors are provided at the outer periphery of the reactor. But the sensitivity of these fixed neutron sensors also declines with time and needs to be calibrated arbitrarily.

In order to calibrate the sensitivity of the LPRMs of BWR and fixed neutron sensors of PWR, a traveling reactor power monitoring system is provided in the nuclear power plant. Generally, the traveling reactor power monitoring system in the BWR is called a Traversing In-core Probe (TIP) monitoring system.

This TIP monitoring system moves a traveling probe that is called a TIP in guide tubes provided in the reactor, and the TIP measures neutron flux in the proximity of the LPRMs while moving. By using measured neutron flux, the sensitivity of the LPRMs is calibrated.

At a PWR power plant, the traveling reactor power monitoring system moves a traveling probe in the reactor, and the sensitivity of the fixed neutron sensors is calibrated by using measured neutron flux by the traveling probe.

The traveling probe is attached to an edge of a probe cable, and the traveling probe moves in the guide tubes by feeding the probe cable from a storage reel and spooling the probe cable onto the storage reel by a motor. This traveling probe measures radioactivity such as neutron and gamma ray as reactor power during moving in the reactor core.

At this point, the shape of each guide tube is curved so as to introduce the traveling probe into the reactor core from outside of the reactor pressure vessel. Therefore, in order to reduce the friction while the traveling probe and the probe cable move in the guide tube, the inside of the guide tubes is coated with lubricant.

But when the drive torque that is a torque necessary for moving the traveling probe and the probe cable exceeds the appropriate value, there is a possibility of damaging the guide tube, the traveling probe and the probe cable by excessive friction. Therefore, it is necessary to monitor the friction inside of the guide tubes by measuring the drive torque.

Therefore, Japanese Patent Laid-open Publication No. 2002-71483 discloses a traveling reactor power monitoring system having a torque sensor attached to the motor shaft. And this torque sensor measures the drive torque automatically.

The above mentioned traveling reactor power monitoring system sets threshold for monitoring the friction as the constant value on the basis of the drive torque at the end point of the guide tube. But the drive torque increases according to the insert distance into the guide tube because the contact area of probe cable and the guide tube increase. Additionally, the drive torque is proportionate to the drive speed of the traveling probe.

Thus, above mentioned traveling reactor power monitoring system is not able to set appropriate drive speed corresponding to appropriate drive torque at each insert position. As the result, there is a possibility that an abnormal friction is caused by moving the traveling probe at excessively fast drive speed. And there is also a possibility that prolonged time of neutron monitoring is taken by moving the TIP at excessively slow drive speed.

### SUMMARY OF THE INVENTION

Accordingly, an aspect of the invention provides a traveling reactor power monitoring system that moves the traveling probe at optimized drive speeds that are slow enough to avoid abnormal friction but fast enough to avoid prolonged times of neutron monitoring.

In accordance with the invention, a traveling reactor power monitoring system includes a probe cable, a traveling probe connected to an edge of the probe cable, a storage reel configured to storage the probe cable, a motor configured to feed the probe cable from the storage reel and spool the probe cable onto the storage reel, a drive control unit configured to drive the motor at a scheduled drive speed, a torque sensor configured to measure a drive torque that is a torque necessary for moving the traveling probe and the probe cable in the guide tubes during the traveling probe moving, an aimed torque DB storing a first threshold and a second threshold at predefined insert position, a drive information DB storing the drive torque received from the torque sensor and the drive speed that the drive control unit moved the traveling probe and a scheduled drive speed processor configured to calculate the scheduled drive speed that is set faster than previous drive speed when the previous drive torque is smaller than the second threshold, and is set slower than previous drive speed when the previous drive torque is larger than the first threshold at each predefined insert position.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawing, which is incorporated in and constitute a part of the specification, illustrates an embodiment of the invention and together with the description, serve to explain the principles of the invention.

FIG. 1 is a block schematic diagram illustrating a TIP monitoring system according to first embodiment of the invention.

FIG. 2 is a graphic representation illustrating how to compare the previous drive torque and threshols 1, 2 according to first embodiment of the invention.

FIG. 3 is a graphic representation illustrating how to set the scheduled drive speed according to first embodiment of the invention.

FIG. 4 is a graphic representation illustrating how to compare the previous drive torque and aimed torque curve according to second embodiment of the invention.

FIG. 5 is a graphic representation illustrating how to set the scheduled drive speed according to second embodiment of the invention.

FIG. 6 is a block schematic diagram illustrating a TIP monitoring system according to third embodiment of the invention.

### DESCRIPTION OF THE EMBODIMENTS

### First Embodiment

Reference will now be made in detail to the present embodiment of the invention, an example of which is illustrated in the accompanying drawing. Wherever possible, the same reference numbers will be used throughout the drawing to refer to the same or like parts.

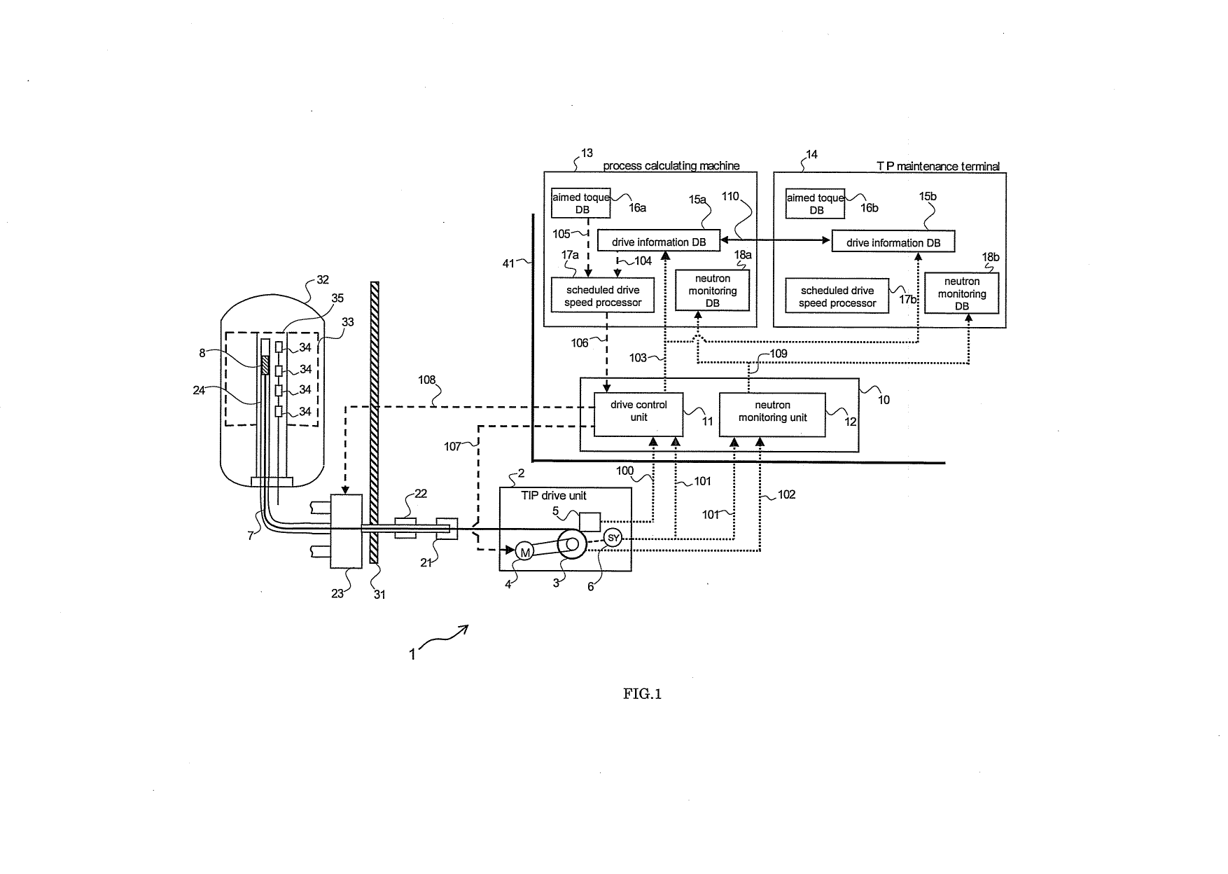

FIG. 1 shows a general Boiled Water Reactor (BWR) power plant. At BWR power plant, the traveling reactor power monitoring system is called a Traversing In-core Prove (TIP) monitoring system 1. And TIP monitoring system 1 moves a traveling probe that is called a TIP 8 in order to measure neutron flux in the reactor core.

Referring to FIG. 1 of the drawing, in a reactor container 31, a reactor pressure vessel 32 is stabilized. A reactor core 33 is a portion where the fission fuel is loaded in the reactor pressure vessel 32. A number of LPRMs 34 are provided in the reactor core 33. A number of guide tubes 24 are provided near the LPRMs 34 (FIG. 1 shows one of the number of guide tubes 24.).

A TIP monitoring system 1 includes a TIP drive unit 2, a probe cable 7, a TIP 8, a drive/monitor device 10, a process calculating machine 13 and a TIP maintenance terminal 14. The TIP drive unit 2 has a storage reel 3, a motor 4, a torque sensor 5 and a probe position signal generator 6.

The drive/monitor device 10, the process calculating machine 13 and the TIP maintenance terminal 14 are provided in a central monitoring room 41. The drive/monitor device 10 has a drive control unit 11 and a neutron monitoring unit 12. The process calculating machine 13 has a drive information data base (DB) 15a, an aimed torque DB 16a, a scheduled drive speed processor 17a and a neutron monitoring DB 18a. The TIP maintenance terminal 14 also has a drive information data base (DB) 15b, an aimed torque DB 16b, a scheduled drive speed processor 17b and a neutron monitoring DB 18b.

The process calculating machine 13 has a primary function that monitor the power plant condition by receiving the signal from the sensors provided in the power plant (not shown). And the TIP maintenance terminal 14 has a primary function that monitor the condition of the TIP monitoring system 1, and display and maintenance the abnormal condition (not shown).

As shown FIG. 1, the TIP drive unit 2 is provided outside of the reactor container 31. One edge of the probe cable 7 is connected to the TIP 8, and the storage reel 3 may store the probe cable 7. The motor 4 is provided so as to feed the probe cable 7 from the storage reel 3 and spool the probe cable 7 onto the storage reel 3 by rotating the storage reel 3. Furthermore, the torque sensor 5 is provided so as to measure the drive torque that is a torque necessary for moving the TIP 8 and the probe cable 7 in the guide tubes 24 by the motor 4.

The probe position signal generator 6 is provided so as to monitor the length of spooling the prove cable 7 onto the reel 3. The probe position signal generator 6 may send the monitored cable length as the probe position signal 101.

Moreover, the drive control unit 11 is connected to the motor 4 and the indexing device 23 so as to send a drive command 107 to the motor 4 and send an indexing command 108 to the indexing device 23. Furthermore, the drive control unit 11 is connected to the torque sensor 5 and the probe position signal generator 6 so as to receive drive torque information 100 from the torque sensor 5 and receive a probe position signal 101 from the probe position signal generator 6.

The TIP 8 may send a probe output signal 102 that indicates the measured neutron flux through a signal transmitting line in the probe cable 7. The TIP 8 is connected to the neutron monitoring unit 12 so as to send the probe output signal 102 to the neutron monitoring unit 12 through the probe cable 7. Additionally, the neutron monitoring unit 12 is connected to the probe position signal generator 6 so as to receive a probe position signal 101 from the probe position signal generator 6.

A shielding vessel 21 is provided outside of the reactor container 31. The shielding vessel 21 may store and keeps the TIP 8 within. A valve assembly 22 is provided outside of the reactor container 31 and inside of the shielding vessel 21. And an indexing device 23 is provided in the reactor container 31. The shielding vessel 21, the valve assembly 22 and the indexing device 23 are communicated by a pipe so as to move the TIP 8 to the indexing device 23 from the shielding vessel 21 through the valve assembly 22.

The valve assembly 22 has a gas valve purging gas in the guide tubes 24 and a cutting valve cutting the pipe at emergency situation. Furthermore, the valve assembly 22 closes the pipe without neutron monitoring.

The guide tubes 24 are connected to the indexing device 23. Each guide tube 24 extends to the under the reactor pressure vessel 32, and curves upwards. Furthermore, each guide tube 24 penetrates the bottom of the reactor pressure vessel 32, and extends vertically into the reactor core 33.

In the central monitoring room 41, the drive control unit 11 is connected to the scheduled drive speed processor 17a, 17b so as to receive a scheduled drive speed information 106 from the scheduled drive speed processor 17a or 17b. Furthermore, the drive control unit 11 is connected to the drive information DB 15a, 15b so as to send a current drive information 103 to drive information DB 15a or 15b.

The scheduled drive speed processor 17a, 17b are connected to the drive information DB 15a, 15b respectively so as to receive a previous drive information 104. Additionally, the scheduled drive speed processor 17a, 17b are connected to the aimed torque DB 16a, 16b respectively so as to receive an aimed torque information 105.

The neutron monitoring unit 12 is connected to neutron monitoring DB 18a, 18b so as to send a neutron monitoring information 109 to the neutron monitoring DB 18a or 18b.

Additionally, the drive information DB 15a is connected to the drive information DB 15b so as to send and receive a synchronizing signal 110 with respect to one another.

At first, measuring neutron flux is described as follows. Calculating the scheduled drive speed is described later. In this embodiment, any one of the process calculating machine 13 and the TIP maintenance terminal 14 may measures neutron flux and calculates the scheduled drive speed. The case that the process calculating machine 13 is used is described below.

Ordinary, the TIP 8 is stored in the shielding vessel 21. At the time of measurement of neutron flux, the drive control unit 11 receives the scheduled drive speed information 106 from the scheduled drive speed processor 17a. The scheduled drive speed information 106 indicates the scheduled drive speed that specifies the drive speed of TIP 8 at each insert position in each guide tube 24.

The drive control unit 11 sends the drive command 107 to the motor 4. The motor 4 feeds the probe cable 7 from the storage reel 3, and moves the TIP 8 to the indexing device 23 from the shielding vessel 21. Furthermore, the drive control unit 11 sends indexing command 108 to the indexing device 23. The indexing device 23 indexes the TIP 8 to the guide tube 24 designated to measure neutron flux indicated in the indexing command 108.

The drive control unit 11 further drives the motor 4 and insert the TIP 8 into the guide tube 24. The drive control unit 11 receives the probe position signal 101 from the probe position signal generator 6, and recognizes the insert position of the TIP 8 in the guide tube 24. At each insert position, the drive control unit 11 moves TIP 8 at the drive speed that the scheduled drive speed information 106 indicates.

The TIP 8 measures neutron flux as reactor power at the predefined point during moving in the guide tube 24, and sends the probe output signal 102 to the neutron monitoring unit 12 through the probe cable 7. And the neutron monitoring unit 12 receives the probe position signal 101 from the probe position signal generator 6.

The neutron monitoring unit 12 sends the measured neutron flux at each predefined point as the neutron flux information 109 to the neutron monitoring DB 18a by using the probe output signal 102 and the probe position signal 101. This neutron flux information 109 is memorized in the neutron monitoring DB 18a and used for the calibration of the sensitivity of the LPRMs 34.

After moving the TIP 8 to the predefined end point of the guide tube 24, the motor control unit 11 reverses motor 4 and spools the probe cable 7 onto the storage reel 4, and moves the TIP 8 back to the indexing device 23. If it is necessary to measure neutron flux in another guide tube 24, the motor control unit 11 sends the indexing command 108 to the indexing device 23, and the indexing device 23 indexes the TIP 8 to the other guide tube 24, and the motor control unit 11 moves the TIP 8 in other guide tube 24.

After moving the TIP 8 in all designated guide tube 24, the motor control unit 11 spools the probe cable 7 onto the storage reel 3 and store the TIP 8 in the shielding vessel 21.

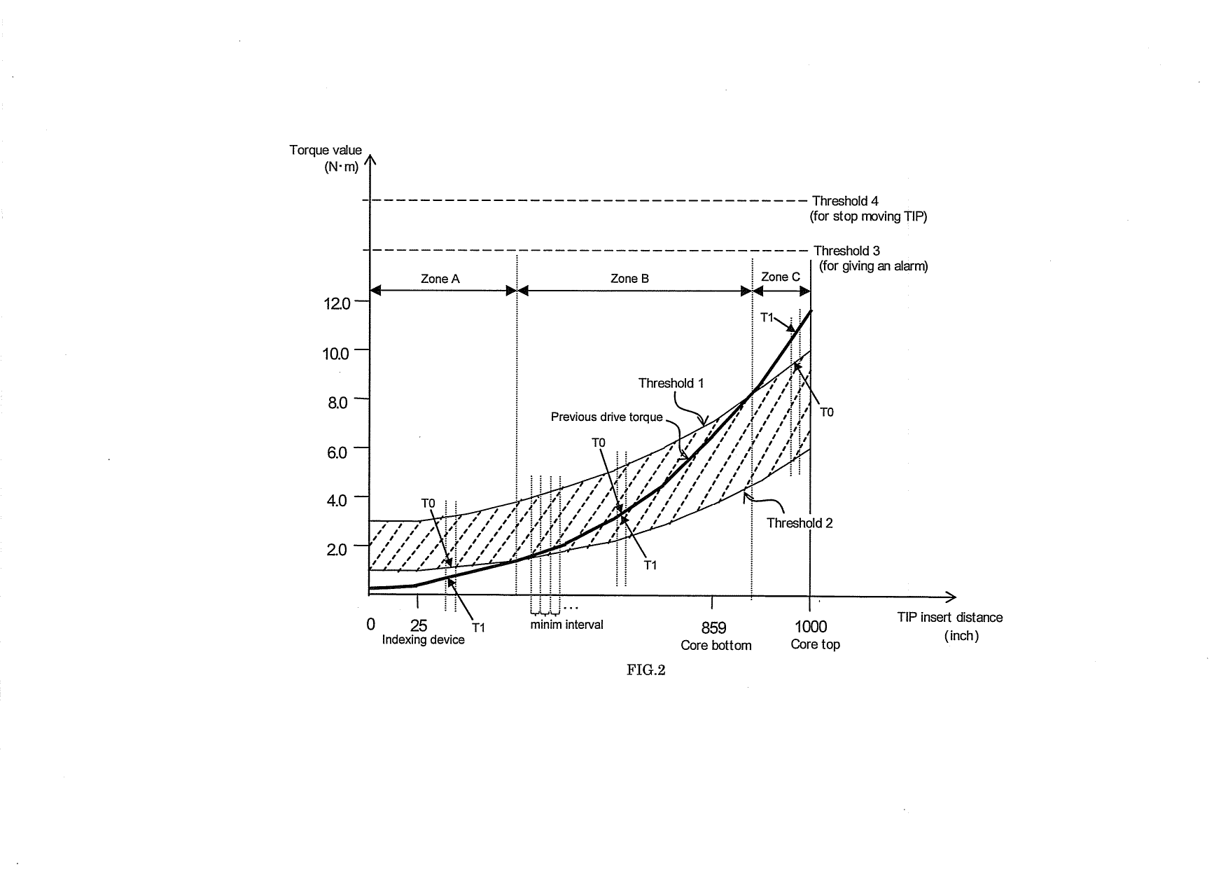

Next, calculating the scheduled drive speed of the TIP 8 is described as follows. As shown FIG. 2, threshold 1 is used for decreasing the drive speed, and threshold 2 is used for increasing the drive speed. Threshold 3 is the upper threshold for giving an alarm. Threshold 4 is the upper threshold for stop moving of the TIP 8.

At this point, threshold 1, 2, 3 and 4 are configured with respect to each guide tube 24 in advance, because the shape and the length of guide tubes 24 are different each other. Furthermore, according to the insert distance of the TIP 8 into the guide tube 24, the contact area of the probe cable 7 and the guide tube 24 increases, and the drive torque that is a torque necessary for moving the TIP 8 and the probe cable in the guide tube 24 increases. Thus, threshold 1 and 2 are configured so as to increase according to insert distance into the each guide tube 24.

Furthermore, at the curved portion of the guide tube 24 under the reactor pressure vessel 32, the drive torque increases more rapidly than the vertical portion per unit distance. Thus, the width of threshold 1 and 2 at the curved portion are set more widely than the vertical portion (that is, the range between threshold 1 and 2 at the curved portion is greater than the range between threshold 1 and 2 at the vertical portion).

The way to set threshold 1, 2, 3 and 4 is described as follows. At first, Ta(x) is measured by moving the TIP8 at past traditional drive speed (Va(x)). Next, Tb(x) is measured by moving the TIP8 at Vb(x). At this point, Vb(x) is 10% faster than Va(x).

Generally, drive torque T increases according to drive speed V. This increase rate (r(x)) between drive torque T and drive speed V is described as formula (1).

Tb(x)−Ta(x)=r(x)×(Vb(x)−Va(x))=r(x)×(1.1×Va(x)−Va(x)) (1)

r(x) at each insert distance is calculated by formula (2) deformed from formula (1).

r(x)=10×(Tb(x)−Ta(x))/Va(x) (2)

Thi(top) is upper limit drive torque at core top. And Thi(top) is set as 80% of the max torque of motor 4. Furthermore, Thi(top) is a value of threshold 1 at core top. Thi(top) is calculated by formula (3) deformed from formula (1).

Thi(top)=Ta(top)+r(top)×(Vhi−Va(top)) (3)

Va(top):past traditional drive speed at core top

Ta(top):drive torque when the TIP 8 moved at Va(top) at core top

r(top): increase rate of Ta(top) at core top

Vhi is a drive speed of Thi(top). Vhi is a drive speed at core top when the drive torque is Thi(top). Vhi is calculated by using formula (4).

Vhi=Va(top)+(Thi(top)−Ta(top))/r(top) (4)

Furthermore, Thi(x) is a drive speed when the TIP 8 moved at Vhi constantly at each insert distance. Threshold 1 is gained by smoothing Thi(x) at each insert distance. Thi(x) is calculated by formula (5)

Thi(x)=Ta(x)+r(x)×(Vhi−Va(x)) (5)

Tlo(top) is lower limit drive torque at core top. And Tlo(top) is set as 60% of the max torque of motor 4. Furthermore, Tlo(top) is a value of threshold 2 at core top. Tlo(top) is calculated by formula (6)

Vlo=Va(top)+(Tlo(top)−Ta(top))/r(top) (6)

Tlo(x) is a drive speed when the TIP 8 moved at Vlo constantly at each insert distance. Threshold 1 is gained by smoothing Tlo(x) at each insert distance. Tlo(x) is calculated by formula (7)

Tlo(x)=Ta(x)+r(x)×(Vlo×Va(x)) (7)

Another way to set threshold 1, 2, 3 and 4 is described as follows. For example, the normal drive torque curve is measured with respect to each guide tube 24 along all insert distance in the normal status at plant routine checkup. This normal drive torque curve may be measured multiple times and averaged or smoothed. And the threshold 1 is gained by adding the predefined value to the normal drive torque at each insert distance, threshold 2 is gained by subtracting the predefined value from the normal drive torque at each insert distance.

Above mentioned normal drive torque curve is also gained by measuring the normal drive torque at the end point and the inlet point of the guide tube 24, and fitting these normal drive torque so as to draw smoothed curve.

And threshold 3 is set as 90% of the max torque drive value of the motor 4, and threshold 4 is set as 95% of the max torque drive value.

The scheduled drive speed processor 17a receives the aimed torque information 105 from the aimed torque DB 16a. Additionally, the scheduled drive speed processor 17a receives the previous drive speed and the previous drive torque as previous drive information 104 from drive information DB 15a. This previous drive speed is the drive speed at previous neutron monitoring, and this previous drive torque is the drive torque measured at previous neutron monitoring. The scheduled drive speed processor 17a compares the threshold 1, 2 and the previous drive torque, and sets the scheduled drive speed by increasing and decreasing from the previous drive speed.

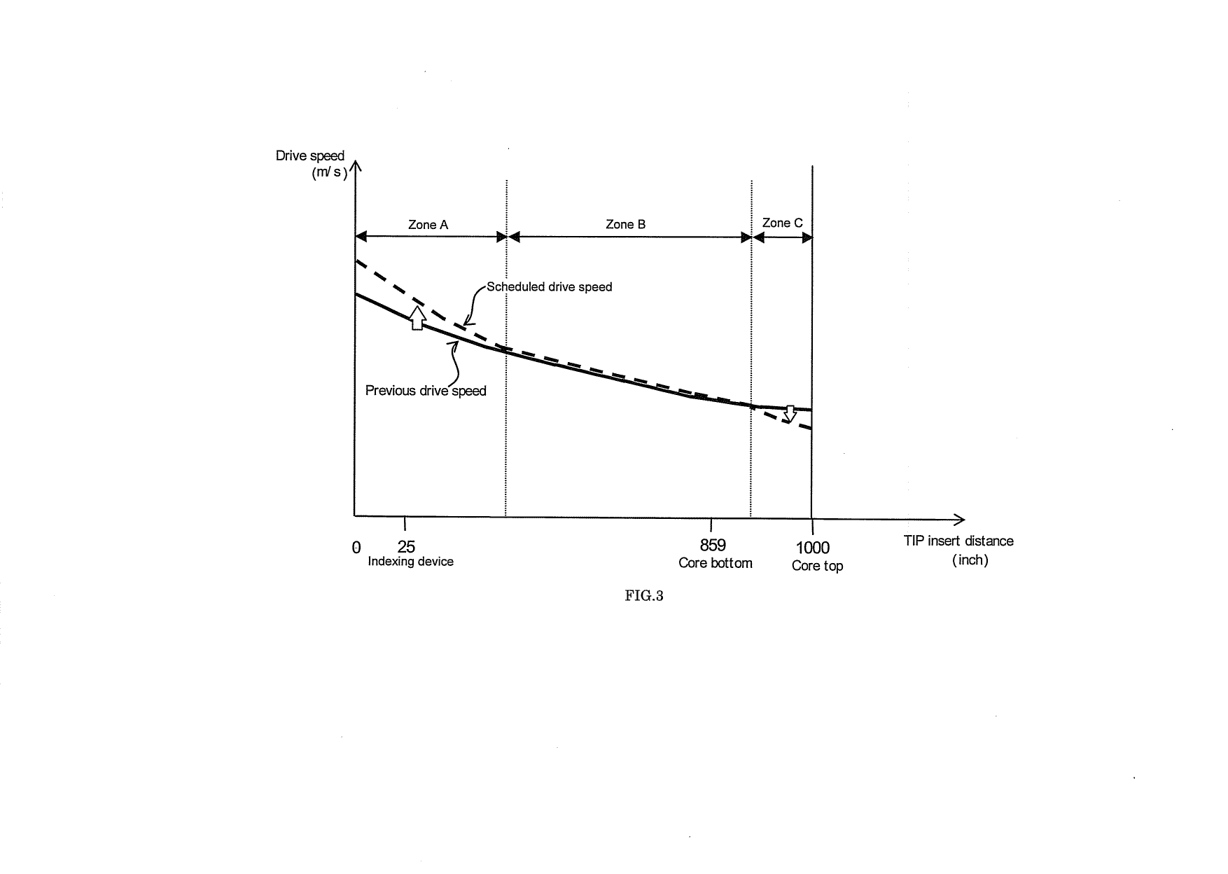

Processing carried out by the scheduled drive speed processor 17a is now described with reference to FIGS. 2 and 3. For example, as shown FIG. 2, at zone A, the previous drive torque is smaller than the threshold 2. Thus, the scheduled drive speed is set faster than previous drive speed as shown FIG. 3.

And as shown FIG. 2, at zone B, the previous drive torque is located between threshold 1 and 2. Thus, the scheduled drive speed is set as same as the previous drive speed as shown FIG. 3.

Furthermore, as shown FIG. 2, at zone C, the previous drive torque is larger than the threshold 1. Thus, the scheduled drive speed is set slower than previous drive speed as shown FIG. 3.

At each guide tube 24, the all insert distance is separated into a number of minim intervals. And above mentioned scheduled drive speed is calculated at each minim interval. At each minim interval, the previous drive speed, threshold 1, and threshold 2 are considered constant value.

Increase and decrease range of the drive speed is calculated by using following formula (8) and (9).

ΔV={(T0−T1)/T0}×V1×W (8)

V2=V1+ΔV (9)

T1: previous drive torque ΔV: increase and decrease range

T0: torque variable number W: weighting factor

V1: previous drive speed V2: scheduled drive speed

At each minim interval, such as zone C, when the previous torque T1 is larger than threshold 1, the torque variable number T0 is configured as threshold 1. When the previous torque T1 is smaller than threshold 2, such as zone A, the torque variable number T0 is configured as threshold 2. When the previous torque Ti is smaller than threshold 1 and larger than threshold 2, such as zone B, the torque variable number T0 is configured as previous drive torque T1, and the scheduled drive speed is maintained at previous drive speed. The weighting factor W is the factor protecting rapid change of the scheduled drive speed, configured as 0<W<1.0, and adjusted as needed.

At each minim interval, the max drive torque value among the drive torque value measured in this minim interval, can be applied to the previous drive torque. By doing so, it is possible to improve safeness.

As shown FIG. 1, The scheduled drive speed processor 17a calculates the scheduled drive speed at each minim intervals, and sends these scheduled drive speeds as the scheduled drive speed information 106 to the drive control unit 11. At this point, threshold 3 and 4 are added to this scheduled drive speed information 106.

The drive control unit 11 receives the scheduled drive speed information 106, and sends drive command 107 to the motor 4, and moves TIP 8 at the scheduled drive speed indicated in the scheduled drive speed information 106 at each insert position. At this time, the torque sensor 5 measures the drive torque, and sends this drive torque as the drive torque information 100 to the drive control unit 11 while TIP 8 is moving.

The drive control unit 11 receives the drive torque information 100, and compares the drive torque and threshold 3, 4. If the drive torque exceeds threshold 3, the drive control unit 11 sends the alarm signal to the process calculation machine 13 or TIP maintenance terminal 14 (not shown), and the process calculation machine 13 or TIP maintenance terminal 14 signals an alarm.

If the drive torque exceeds threshold 4, the drive control unit 11 stop moving the TIP 8, and reverses the motor 4 and retrieves the TIP 8 by predefined length, and insert again at slower drive speed. If the drive torque exceeds threshold 4 again, the drive control unit 11 withdraws the TIP 8 again, and inserts the TIP 8 at further slower drive speed. When the drive torque continues to exceed threshold 4 at predefined slower speed, the drive control unit 11 stops driving the motor 4.

Besides this, if the drive torque exceeds threshold 4, the drive control unit 11 stops moving the TIP 8, and withdraws the TIP 8, and inserts again at same drive speed. If the drive torque underruns threshold 4, the drive control unit 11 continues moving the TIP 8. If the drive torque exceeds threshold 4 again, the drive control unit 11 inserts the TIP 8 again at same drive speed. When the drive torque exceeds threshold 4 at predefined times, the drive control unit 11 stop driving the motor 4. In this modification, the drive control unit 11 can inserts the TIP 8 more quickly. Above inserting formula can be carried out at not only during inserting the TIP 8 into the guide tube 24 but also during drawing the TIP 8 from the guide tube 24.

Furthermore, the drive control unit 11 homologizes the drive speed and the drive torque at each insert position by using the probe position signal 101, the drive torque information 100 at current neutron monitoring. And the drive control unit 11 sends this information as the current drive information 103 to the drive information DB 15a. The current drive information 103 memorize in the drive information DB 15a is used for next calculation of the scheduled drive speed.

Additionally, the drive information DB 15a and 15b update each other by sending and receiving the synchronizing signal 110 that indicates drive information so far. Furthermore, it is possible to select normal one within the process calculation machine 13 and/or the TIP maintenance terminal 14 by detecting the break of synchronizing signal 110 or bad condition of other one.

In this embodiment, it is possible to optimize the drive speed, and measure neutron flux safely and fast by calculating the scheduled drive speed so as to set the drive torque between the threshold 1 and 2. And when the drive torque exceeds the threshold 4, it is possible to continue the neutron monitoring by inserting the TIP 8 again.

Additionally, this embodiment may be modified as below. At each minim interval, the averaged drive torque value among the drive torque value measured in this minim interval may be applied to the previous drive torque. In this modification, it is possible to prevent the control incapability and control more stably.

### Second Embodiment

This embodiment differs from the first embodiment in that the scheduled drive speed processor 17a, 17b calculates the scheduled drive speed by using an aimed torque curve.

This aimed torque curve is calculated just like above threshold 1 and 2. Tmid(top) is aimed drive torque at core top. And Tmid(top) is set as 70% of the max torque of motor 4. Tmid(top) is calculated by formula (10)

Vmid=Va(top)+(Tmid(top)−Ta(top))/r(top) (10)

Tmid (x) is a drive_{,} speed when the TIP 8 moved at Vmid constantly at each insert distance. The aimed drive torque 1 is gained by smoothing Tmid(x) at each insert distance. Tmid(x) is calculated by formula (11)

Tmid(x)=Ta(x)+r(x)×(Vmid−Va(x)) (11)

The normal drive torque curve measured with respect to each guide tube 24 along all insert distance in the normal status at plant routine checkup is applied to the aimed torque curve. This aimed torque curve is stored in the aimed torque DB 16a, 16b.

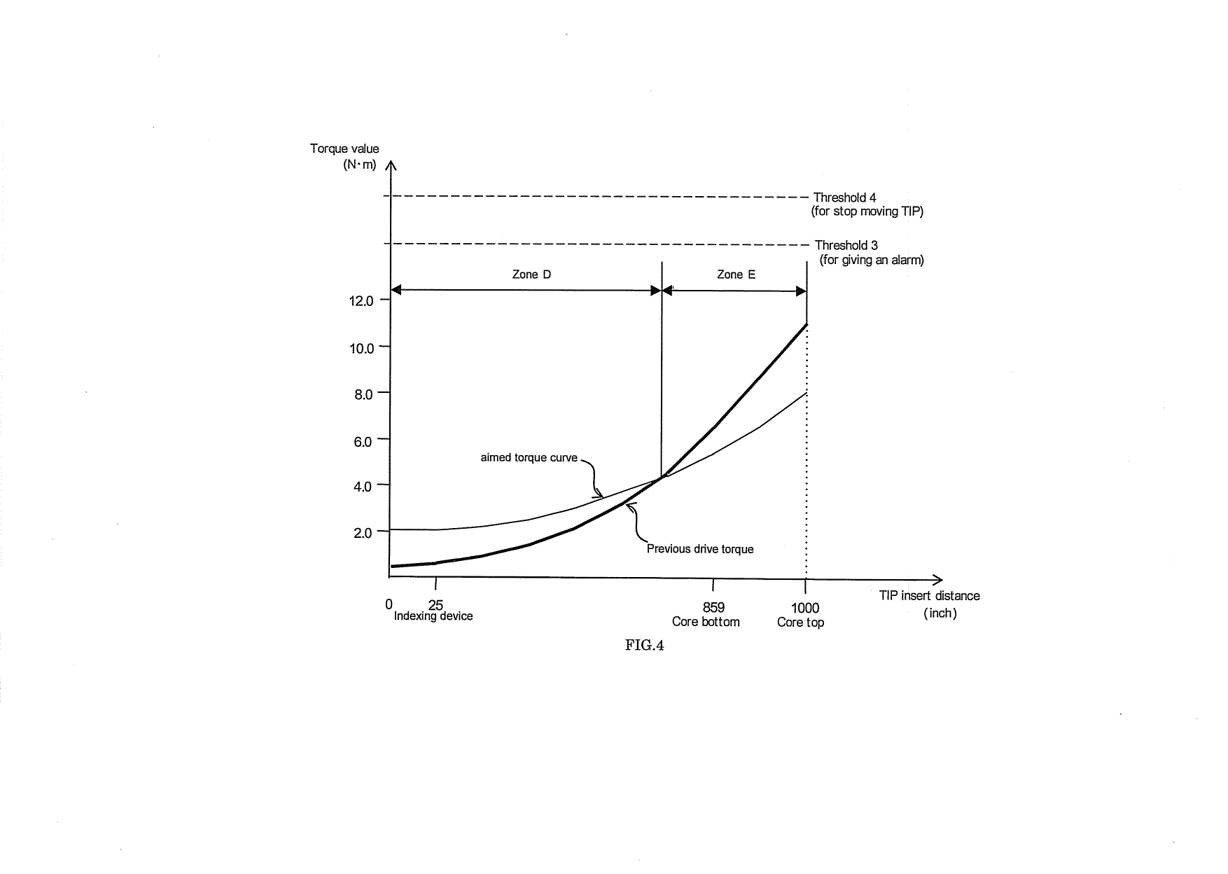

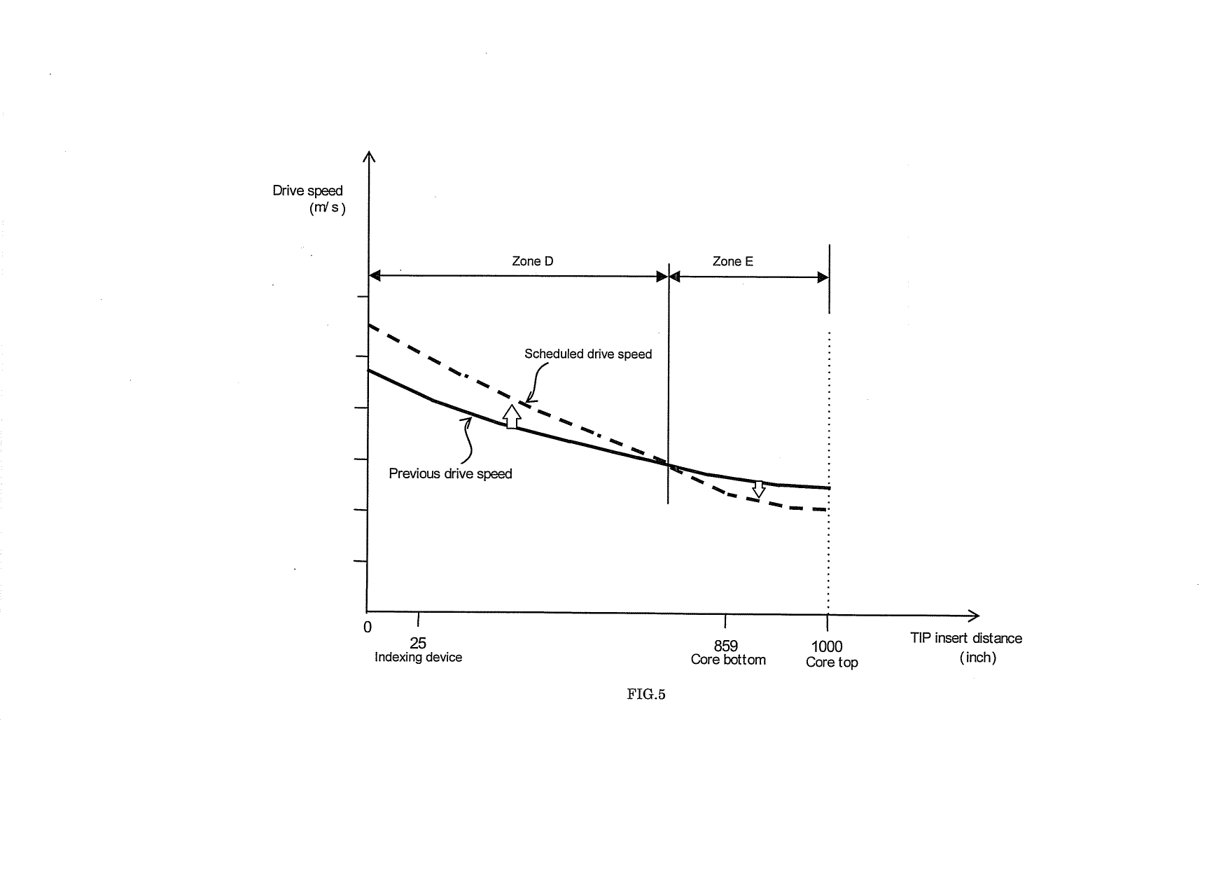

As shown FIG. 4, at zone D, the previous drive torque is smaller than the aimed torque curve. Thus, the scheduled drive speed is set faster than previous drive speed as shown FIG. 5.

And as shown FIG. 4, at zone E, the previous drive torque is larger than the aimed torque curve. Thus, the scheduled drive speed is set slower than previous drive speed as shown FIG. 5.

Increase and decrease range of the drive speed is calculated by above formulae (8) and (9). And the torque variable number TO is configured as the value of the aimed torque curve at each minim interval.

In this embodiment, it is possible to control the TIP 8 more safely and fast by calculating the scheduled drive speed so as to bring the drive torque to the aimed torque curve.

### Third Embodiment

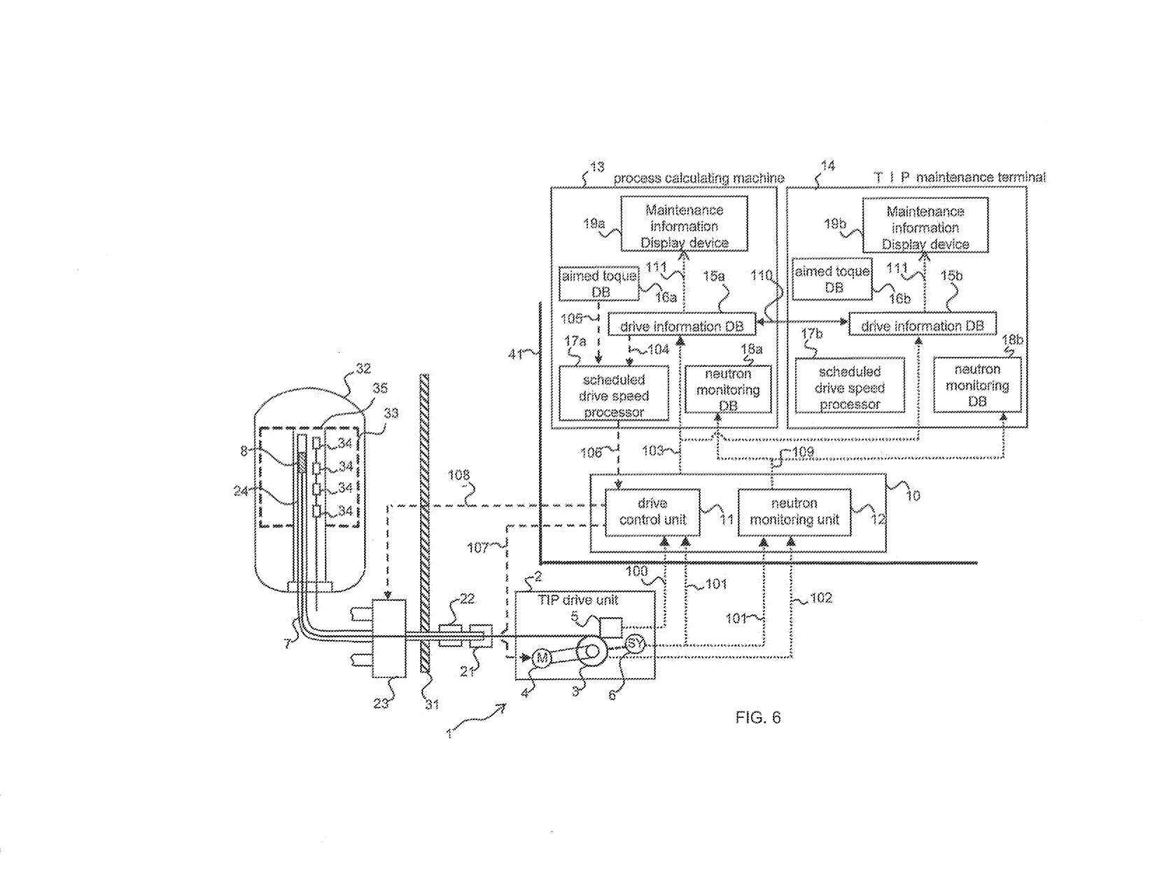

FIG. 6 is a block schematic diagram illustrating a TIP monitoring system according to third embodiment of the invention. This embodiment differs from the first embodiment in that TIP monitoring system 1 additionally has a maintenance information display device 19a, b in the process calculating machine 13 and TIP maintenance terminal 14 respectively. The maintenance information display device 19a, b are connected to the drive information DB 15a, b respectively so as to receive a maintenance information signal 111.

The maintenance information display device 19a receives the maintenance information signal 111 from the drive information DB 15a. This maintenance information signal 111 indicates past multiple drive torque records of each guide tube 24.

The maintenance information display device 19a calculates a predicted drive torque of next time neutron measurement. For example, this predicted drive torque is calculated by linear prediction of past multiple drive torque at each inset distance.

When the predicted drive torque exceeds the threshold 4, the maintenance information display device 19a displays maintenance information by using a LCD monitor or a projector. For example, maintenance information includes the guide tube 24 and insertion distance where the predicted drive torque exceeds the threshold 4. Additionally, displaying this information just after moving the TIP 8 at each guide tube 24, it is able to maintenance the TIP monitoring system 1 promptly.

In this embodiment, it is possible to control the TIP 8 more safely and quickly by calculating the scheduled drive speed so as to bring the drive torque to the aimed torque curve.

The above described embodiments can be modified in various different ways as pointed out below. At Pressurized Water Reactor (PWR) power plant, fixed neutron sensors are provided at outer periphery of the reactor as substitute for LPRMs 34. Thus, above mentioned TIP monitoring system 1 is able to be applied to the PWR power plant as a traveling reactor power monitoring system.

Furthermore, at some PWR power plant, guide tubes 24 penetrates upper portion of the reactor pressure vessel, and the traveling probe moves to the core bottom form the core top. In this case, drive torque increases according to insert distance to the core bottom. Thus threshold 1, 2 and aimed torque curve are defined to increase according to insert distance to the core bottom.

The traveling power monitoring system can connect a gamma thermo meter as the traveling probe. This gamma thermo meter can measure gamma ray in the reactor core during moving. In this case, the traveling power monitoring system is able to measure gamma ray as reactor power.

Additionally, scheduled drive speed processor 17a, 17b are able to use not only previous drive information 104 but also the forepast drive information that indicates the forepast drive speed and the forepast drive torque. For example, the forepast drive information includes the before last time drive speed and the drive torque, the average value of the previous and the before last time drive speed and drive torque end so on.

Furthermore, the drive information DB 15a, 15b are able to store the forepast drive information that is previously measured at other power plant. By doing so, it is possible to optimize the drive speed without measuring and storing the forepast drive information of the plant under operation.

Additionally, it does not need to calculate the scheduled drive speed at every minim interval at one guide tube 24. The scheduled drive speed processor 17a, 17b can calculate the scheduled drive speed at the predefined insert position. For example, the scheduled drive speed processor 17a, 17b can calculate the scheduled drive at intervals of 10 or 20 inch in one guide tube 24.

In this modification, the aimed torque DB 16a, 16b memorize threshold 1, 2 or aimed torque threshold at the predefined insert position at least. And the drive information DB 15a, 15b stores the drive information at the predefined insertion position at least. At this point, the drive torque changes rapidly at the curved portion of the guide tube 24 compared to other potion. Thus, it is preferred to store above threshold 1, 2, aimed torque threshold and the drive information at the curved portion at least.

What is claimed is

1. A traveling reactor power monitoring system,
comprising:
a probe cable;
a traveling probe connected to an edge of the probe cable;
a storage reel configured to storage the probe cable;
a motor configured to feed the probe cable from the storage reel and spool the probe cable onto the storage reel;
a drive control unit configured to rotate the motor and move the traveling probe at a scheduled drive speed at each insert position in the guide tube;
a torque sensor configured to measure a drive torque that is a torque necessary for moving the traveling probe and the probe cable in the guide tubes during the traveling probe moving;
an aimed torque DB storing a first threshold and a second threshold at predefined insert position in the guide tube;
a drive information DB storing the drive torque received from the torque sensor and the drive speed that the drive control unit moved the traveling probe as a drive information;
and
a scheduled drive speed processor configured to set the scheduled drive speed faster than a forpast drive speed when a forpast drive torque is smaller than the second threshold, set the scheduled drive speed slower than the forpast drive speed when the forpast drive torque is larger than the first threshold at each predefined insert position.

2. The traveling reactor power monitoring system of claim 1,
the aimed torque DB storing an aimed torque threshold at predefined insert position in the guide tube;
the scheduled drive speed processor configured to set the scheduled drive speed faster than a forpast drive speed when a forpast drive torque is smaller than the aimed torque threshold, and set the scheduled drive speed slower than the forpast drive speed when the forpast drive torque is larger than the aimed torque threshold at each predefined insert position.

3. The traveling reactor power monitoring system of claim 1, wherein:
the aimed torque DB further memorizes a third threshold, and
the drive control unit give an alarm when the drive torque exceeds the third threshold.

4. The traveling reactor power monitoring system of claim 1, wherein:
the aimed torque DB further memorizes a forth threshold, and
the drive control unit stop the moving of the TIP and move the TIP again when the drive torque exceeds the forth threshold.

5. The traveling reactor power monitoring system of claim 1 further comprising;
a process calculating machine having a first scheduled drive speed processor;
a TIP maintenance terminal having a second scheduled drive speed processor;
wherein one of the first and second scheduled drive speed processor and the TIP maintenance terminal calculates the scheduled drive speed.

6. The traveling reactor power monitoring system of claim 5,
wherein the process calculating machine and the TIP maintenance terminal having the drive information DB respectively, and receive the drive information each other, and update the drive information DB.

7. The traveling reactor power monitoring system of claim 1,
wherein:
the scheduled drive speed processor separates the insert distance into a number of minim intervals, and calculates the scheduled drive speed at each minim intervals, and
the previous drive torque at each minim interval is the max drive torque value among the drive torque value measured in each minim interval.

8. The traveling reactor power monitoring system of claim 1,
wherein:
the scheduled drive speed processor separates the insert distance into a number of minim intervals, and calculates the scheduled drive speed at each minim intervals, and
the previous drive torque at each minim interval is the averaged drive torque value among the drive torque value measured in each minim interval.

9. The traveling reactor power monitoring system of claim 2, wherein:
the aimed torque DB further memorizes a third threshold, and
the drive control unit give an alarm when the drive torque exceeds the third threshold.

10. The traveling reactor power monitoring system of claim 2, wherein:
the aimed torque DB further memorizes a forth threshold, and
the drive control unit stop the moving of the TIP and move the TIP again when the drive torque exceeds the forth threshold.

11. The traveling reactor power monitoring system of claim 2 further comprising;
a process calculating machine having a first scheduled drive speed processor;
a TIP maintenance terminal having a second scheduled drive speed processor;
wherein one of the first and second scheduled drive speed processor and the TIP maintenance terminal calculates the scheduled drive speed.

12. The traveling reactor power monitoring system of claim 11,
wherein the process calculating machine and the TIP maintenance terminal having the drive information DB respectively, and receive the drive information each other, and update the drive information DB.

13. The traveling reactor power monitoring system of claim 2,
wherein:
the scheduled drive speed processor separates the insert distance into a number of minim intervals, and calculates the scheduled drive speed at each minim intervals, and
the previous drive torque at each minim interval is the max drive torque value among the drive torque value measured in each minim interval.

14. The traveling reactor power monitoring system of claim 2,
wherein:
the scheduled drive speed processor separates the insert distance into a number of minim intervals, and calculates the scheduled drive speed at each minim intervals, and
the previous drive torque at each minim interval is the averaged drive torque value among the drive torque value measured in each minim interval.

15. A traveling reactor power monitoring system,
comprising:
a probe cable;
a traveling probe connected to an edge of the probe cable;
a storage reel configured to storage the probe cable;
a motor configured to feed the probe cable from the storage reel and spool the probe cable onto the storage reel;
a drive control unit configured to rotate the motor and move the traveling probe at a scheduled drive speed at each insert position in the guide tube;
a torque sensor configured to measure a drive torque that is a torque necessary for moving the traveling probe and the probe cable in the guide tubes during the traveling probe moving;
a drive information DB storing the drive torque received from the torque sensor as a drive information;
and
a maintenance display configured to calculate a predicted drive torque by using forpast drive torque in the drive information DB, and display a maintenance information when the predicted drive torque exceeds a predefined threshold.

16. A method for driving a traveling probe, comprising:
moving a traveling probe in guide tubes at a scheduled drive speed;
measuring a drive torque while moving the traveling probe;
storing the drive torque and the drive speed of the traveling probe; and
calculating the scheduled drive speed that is set faster than a previous drive speed when a previous drive torque is smaller than a second threshold, and the scheduled drive speed that is set slower than the previous drive speed when the previous drive torque is larger than a first threshold at each predefined insert position.
